(19) United States
(12) Patent Application Publication
(10) Pub. No.: US 2012/0104138 A1
(43) Pub. Date: May 3, 2012

(54) ENGAGEMENT DEVICE OF A SAFETY BELT

(76) Inventor: KUO-HAO LEE, TAIPEI (TW)

(21) Appl. No.: 13/192,539

(22) Filed: Jul. 28, 2011

(30) Foreign Application Priority Data
Oct. 27, 2010 (TW) 099220751

(51) Int. Cl. B60R 22/40

(52) U.S. Cl. 242/384.2

(57) ABSTRACT

An engagement device of a safety belt is mounted on one side of a safety belt retractor of the safety belt, and has a body, and an actuating assembly and a stopping assembly mounted inside the body. The body has a seat formed therein and at least one stopper formed around a perimeter of the seat, so that a steel ball of the stopping assembly is held in the seat. Besides regularly locking the safety belt retractor during an emergency braking or a collision, the safety belt does not lock the safety belt retractor when the vehicle drives on a moderately slanted road as the steel ball is blocked by the at least one stopper without further pushing a rocking arm of the stopping assembly to engage and lock a ratchet wheel of the actuating assembly. Accordingly, the driving safety and comfort can be both taken into account.

### BACKGROUND OF THE INVENTION

1. Field of the Invention

The present invention relates to an engagement device of a safety belt, and more particularly to an engagement device connected to a safety belt retractor of a vehicle, automatically locking the safety belt retractor when the vehicle has a collision or an emergency braking or drives on an excessively slanted road, and unlocking the safety belt retractor when the vehicle drives on a moderately slanted road.

2. Description of the Related Art

With reference to FIGS. 7 and 8, a conventional engagement device of a safety belt is mounted on one side of a retractor 5 of the safety belt, and has a body 6, an actuating assembly 63, a seat 62, a steel ball 65 and a rocking arm 64. The body 6 has a fixed part 60, a detachable part 61 assembled with the fixed part 60 to form the body 6, and a chamber defined in the body 6. The actuating assembly 63 is mounted in the body 6, is connected with a rotation shaft of the safety belt retractor 5, and has a ratchet wheel 631 and multiple ratchet teeth formed on a perimeter of the ratchet wheel 631. The seat 62 is mounted on a bottom inside the body 6 to rotatably hold the steel ball 65 therein. One end of the rocking arm 64 is pivotally mounted on an inside portion of the body 6, the other end of the rocking arm 64 is a free end, and a middle portion of the rocking arm 64 abuts against a top of the steel ball 65. The rocking arm 64 has a pawl 641 formed on and protruding upwardly from the free end.

The engagement device can be applied to a vehicle and is combined with a safety belt retractor. When the vehicle has a collision or an emergency braking, or drives on a road with a steep slope, with reference to FIG. 9, the steel ball 65 departs from the seat 62 when the steel ball 65 is subjected to an inertial force and deviates from its regular position dramatically, and further pushes the free end of the rocking arm 64 upwardly. The pawl 641 of the rocking arm 64 then engages in between the ratchet teeth so that the ratchet wheel 631 is unable to rotate and the rotation shaft of the safety belt retractor 5 is locked. As a result, the safety belt is unable to be further pulled out, so the driver and passengers inside the vehicle can be protected as the safety belt is intended for.

However, when the engagement device is applied to specialized vehicles, such as all-terrain vehicles, dune buggies and the like, and when the vehicles drive on a rough road or a road with a slope, the steel ball 65 in the engagement device of the safety belt easily departs from the seat 62 and pushes the rocking arm 64 upwardly. Then, the pawl 641 of the rocking arm 64 engages in between the ratchet teeth, so the ratchet wheel 63 is unable to rotate and the driver and passengers are overly and uncomfortably tied on the seats because the safety belt fails to be adjustable as intended.

### SUMMARY OF THE INVENTION

An objective of the present invention is to provide an engagement device not repeatedly and unexpectedly locking the safety belt when a vehicle equipped with the engagement device and the safety belt drives under a rough road condition.

To achieve the foregoing objective, the engagement device of a safety belt is adapted to be mounted on a safety belt retractor of the safety belt, and has a body, an actuating assembly, and a stopping assembly. The body is hollow and has a seat. The seat is formed on a lower portion inside the body and has a holding portion and at least one stopper. The holding portion is circularly formed in the seat and has a center and a bottom. The at least one stopper is formed around a perimeter of the holding portion.

The actuating assembly is mounted inside the body and has a ratchet wheel and multiple ratchet teeth. The ratchet wheel is adapted to connect with a rotation shaft of the safety belt retractor. The ratchet teeth are formed around a perimeter of the ratchet wheel.

The stopping assembly has a steel ball and a rocking arm. The steel ball is rotatably mounted on the holding portion of the seat. The rocking arm has one end, a pawl and a middle portion. The end is pivotally mounted on an inside portion of the body. The pawl is formed on the other end of the rocking arm for engaging in between the ratchet teeth of the ratchet wheel and preventing the ratchet wheel from rotating. The middle portion abuts against the steel ball.

When a vehicle equipped with the engagement devices in corresponding safety belts has a collision or an emergency braking or drives under a rough road condition, the safety belts tie the driver and passengers on the seats as the safety belts are intended for. Additionally, when the vehicle drives on a moderately slanted road, the steel ball is held by the at least one stopper of the seat inside the engagement device so that the steel ball does not push the rocking arm upwardly and the pawl of the rocking arm does not engage the ratchet teeth of the ratchet wheel. Accordingly, the ratchet wheel can be freely rotated, the safety belt retractor is not easily and unexpectedly locked and tied, and the safety belt does not uncomfortably tie the driver or a passenger on the seat, thereby taking driving safety and comfort into account.

Other objectives, advantages and novel features of the invention will become more apparent from the following detailed description when taken in conjunction with the accompanying drawings.

### BRIEF DESCRIPTION OF THE DRAWINGS

FIG. 1 is an exploded view of a safety belt retractor and an engagement device of a safety belt in accordance with the present invention;

FIG. 2 is an enlarged perspective view of a fixed part of a body of the engagement device in FIG. 1;

FIG. 3 is an enlarged side view of the engagement device in FIG. 1 in the absence of a detachable part of a body;

FIG. 4 is an enlarged front view in partial section of a seat, a steel ball and a rocking arm of the engagement device in FIG. 1;

FIG. 5 is an operational side view of the engagement device in FIG. 1 in the absence of a detachable part of a body;

FIG. 6 is an enlarged operational front view in partial section of a seat, a steel ball and a rocking arm of the engagement device in FIG. 1;

FIG. 7 is an exploded view of a safety belt retractor and a conventional engagement device of a safety belt;

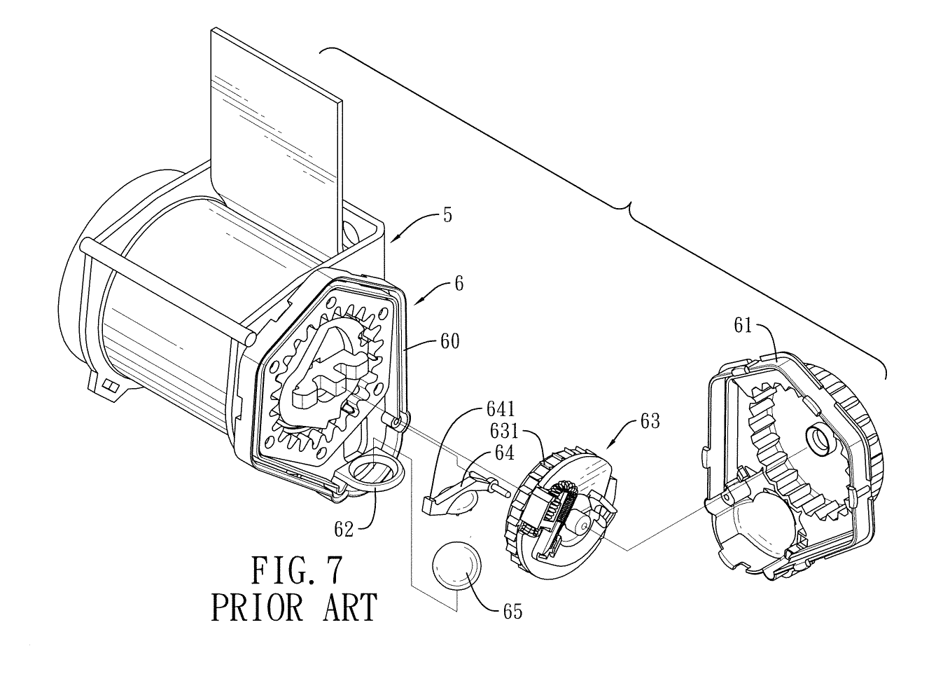

FIG. 8 is a side view of the conventional engagement device in FIG. 7 in the absence of a detachable part of a body; and

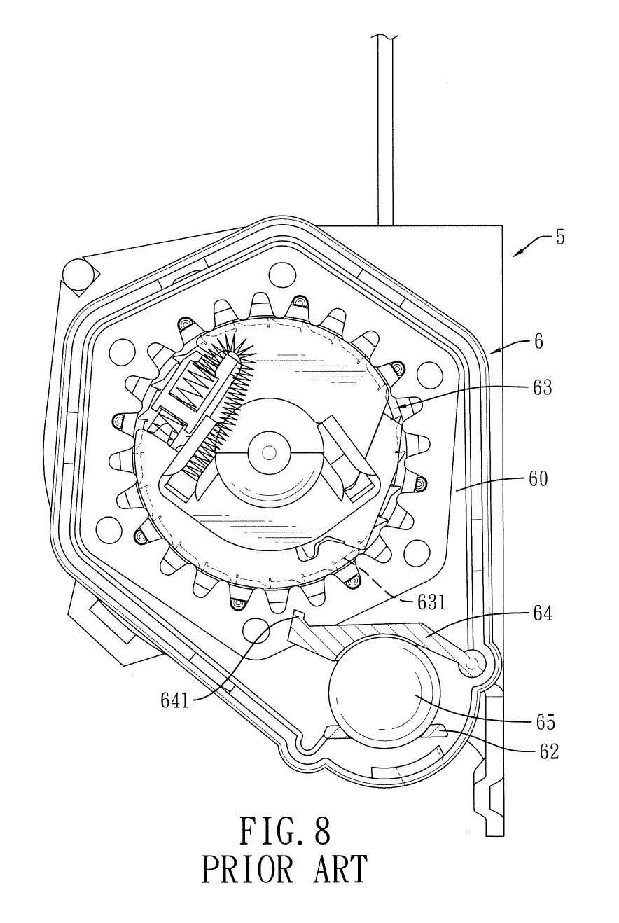

FIG. 9 is an operational side view of the conventional engagement device in FIG. 7 in the absence of a detachable part of a body.

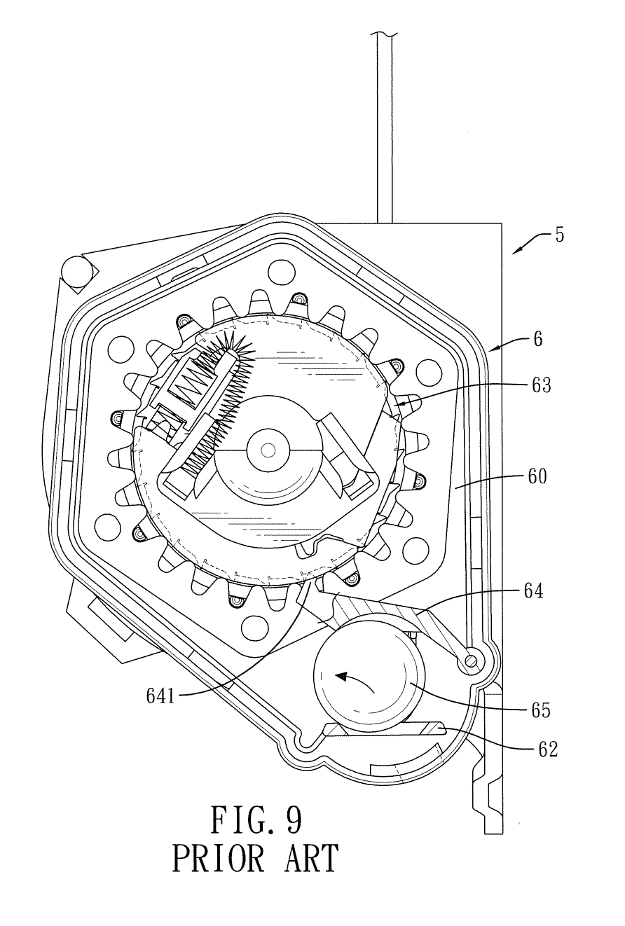

### DETAILED DESCRIPTION OF THE INVENTION

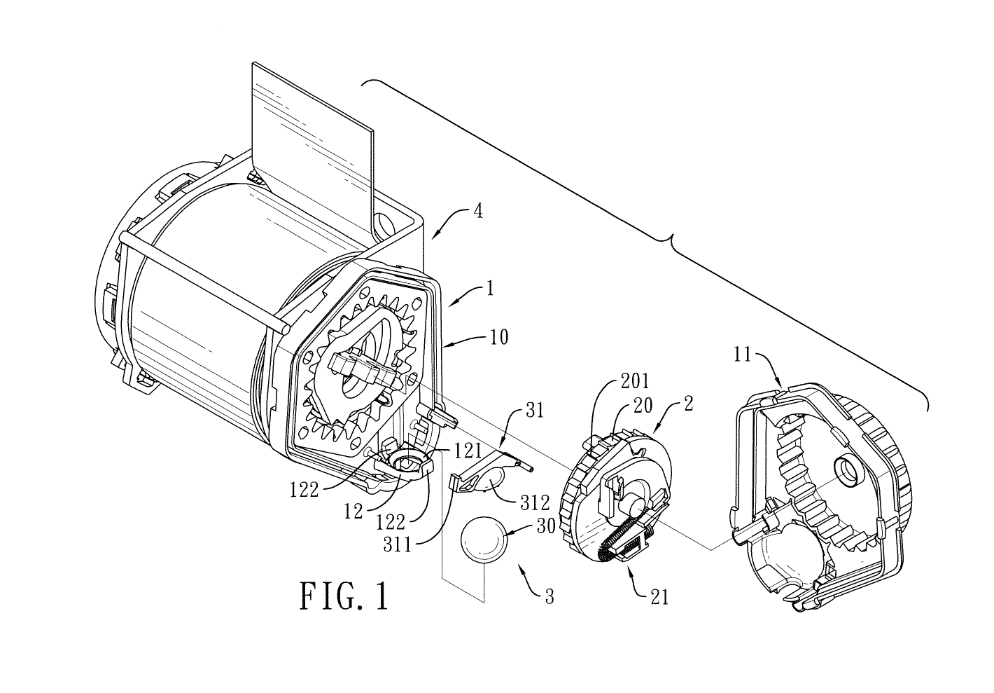

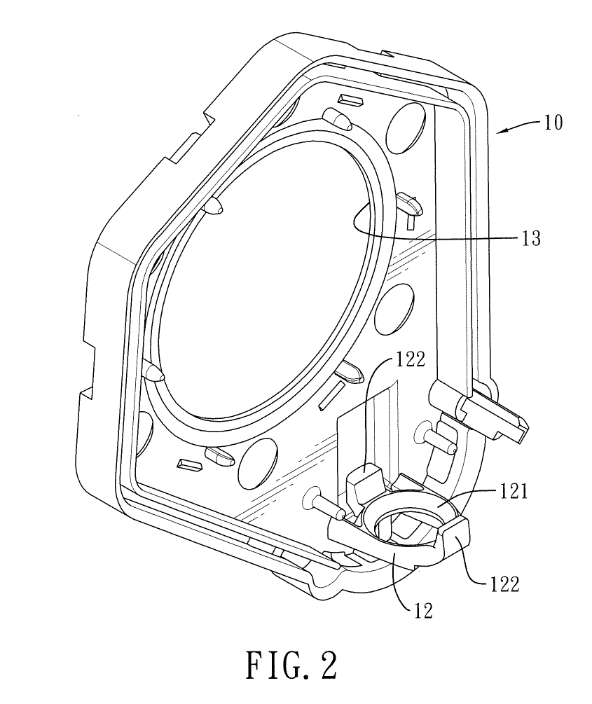

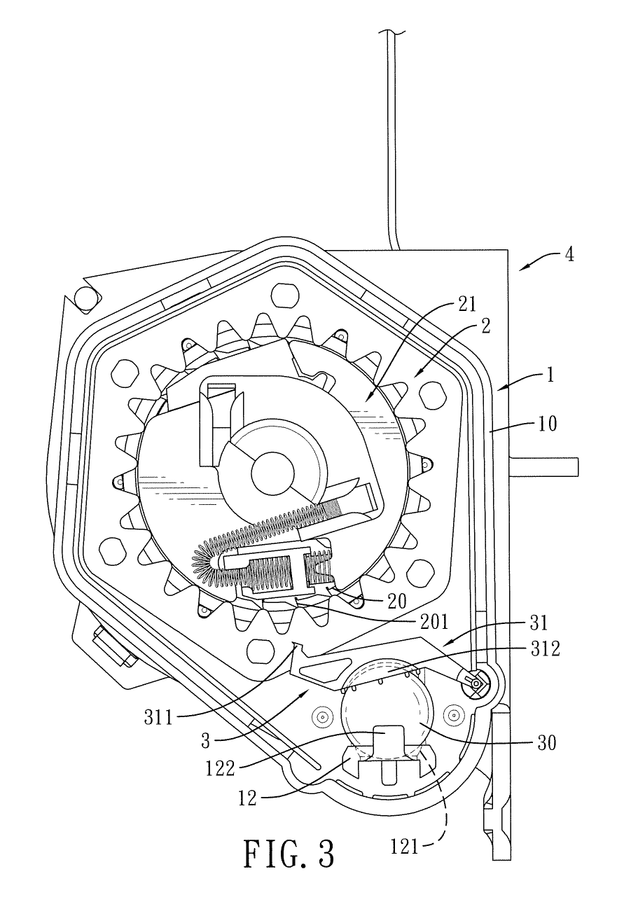

With reference to FIGS. 1 to 3, an engagement device of a safety belt in accordance with the present invention has a body 1, an actuating assembly 2 and a stopping assembly 3.

The body 1 is hollow and is mounted on one side of a safety belt retractor 4. The body has a fixed part 10 and a detachable part 11. The fixed part 10 is mounted on one side of the safety belt retractor 4 and has a through hole 13 formed through the fixed part 10 for a rotation shaft of the safety belt retractor 4 to penetrate through the through hole 13. The detachable part 11 is assembled with the fixed part 10 by means of engagement or screws to cover the fixed part 10 and form the body 1. The body 1 further has a seat 12 formed on a lower portion inside the fixed part 10 of the body 1. The seat 12 has a holding portion 121 and multiple stoppers 122. The holding portion 121 is circularly formed in the seat 12 and has a hole centrally formed through a bottom of the holding portion 121. The stoppers 122 are formed around a perimeter of the holding portion 121, and align with each other symmetrically or asymmetrically with respect to a center of the holding portion 121, depending on a design requirement of a vehicle to which the engagement device is mounted. In the present embodiment, the seat 12 has two stoppers 122 aligning with each other symmetrically with respect to the center of the holding portion 121.

The actuating assembly 2 is mounted inside the body 1 and has a ratchet wheel 20, a clutch 21 and multiple ratchet teeth 201. The rotation shaft of the safety belt retractor 4 is connected with one side of the ratchet wheel 20. The clutch 21 is mounted on the other side of the ratchet wheel 20. The ratchet teeth 201 are formed around a perimeter of the ratchet wheel 20.

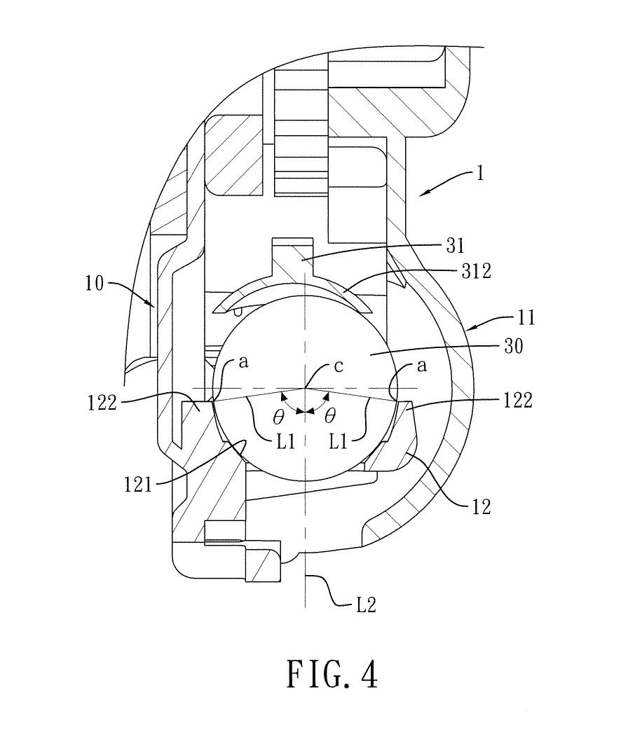

The stopping assembly 3 has a steel ball 30 and a rocking arm 31. The steel ball 30 is rotatably mounted in the holding portion 121 of the seat of the body 10. With further reference to FIG. 4, an inclination angle θ is defined by a line L1 passing through a center c of the steel ball 30 and a top inner edge a of each stopper and a line L2 vertically passing through the center of the steel ball 30, and can be set up based on customized demands of the vehicles. The inclination angle θ is in a range of 27° to 90°. A height of the stopper 122 is determined by the range of the inclination angle within which the safety belt can still be extended and retracted.

One end of the rocking arm 31 is pivotally mounted on an inside portion of the body 10, and the other end of the rocking arm 31 is a free end. The rocking arm 31 has a pawl 311 formed on and protruding upwardly from the free end for engaging in between the ratchet teeth 201 of the ratchet wheel 20 to prevent the ratchet wheel 20 from rotating in one direction. A middle portion of the rocking arm 31 abuts against a top of the steel ball 30, and the rocking arm 31 has a cap 312 formed on the middle portion and covering and abutting against the steel ball 30.

When implemented to a vehicle, the engagement device is assembled with a safety belt retractor to prevent the safety belt from extending or retracting when the vehicle drives on an excessively slanted road and has a collision or an emergency braking but keeps the safety belt intact when the vehicle drives on a moderately slanted road.

When the vehicle is driven under a normal condition, the steel ball 30 of the stopping assembly 3 stays in the holding portion 121 of the seat 12 of the body 1, and a gap is presented between the pawl 311 on the free end of the rocking arm 31 and the ratchet wheel 20 of the actuating assembly 2. Hence, the safety belt retractor 4 can freely drive the ratchet wheel 20 of the actuating assembly 2 to rotate.

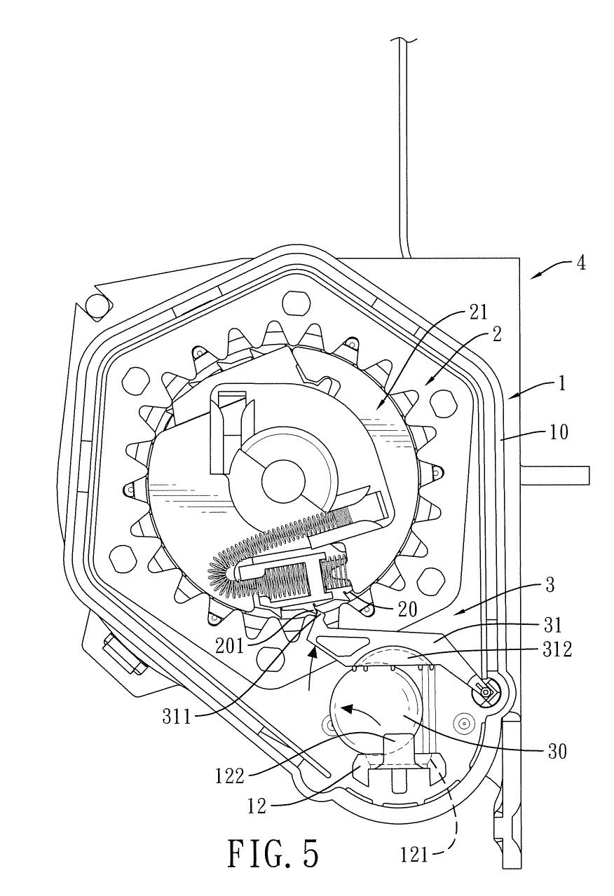

With reference to FIG. 5, when the vehicle has a collision or an emergency braking or drives on a road with a steep slope, the steel ball 30 departs from the holding portion 121 of the seat 12, further pushes the free end of the rocking arm 31 upwardly when the steel ball 30 is subjected to an inertial force and the steel ball 30 deviates from the vertical center line L2 at an angle that exceeds the inclination angle θ. The pawl 311 then engages in between the ratchet teeth 201 of the ratchet wheel 20, the ratchet wheel 20 is unable to rotate, and the rotation shaft of the safety belt retractor 4 is locked. Consequently, the safety belt is unable to be further pulled out, and the driver or a passenger inside the vehicle can be protected as the safety belt is intended for.

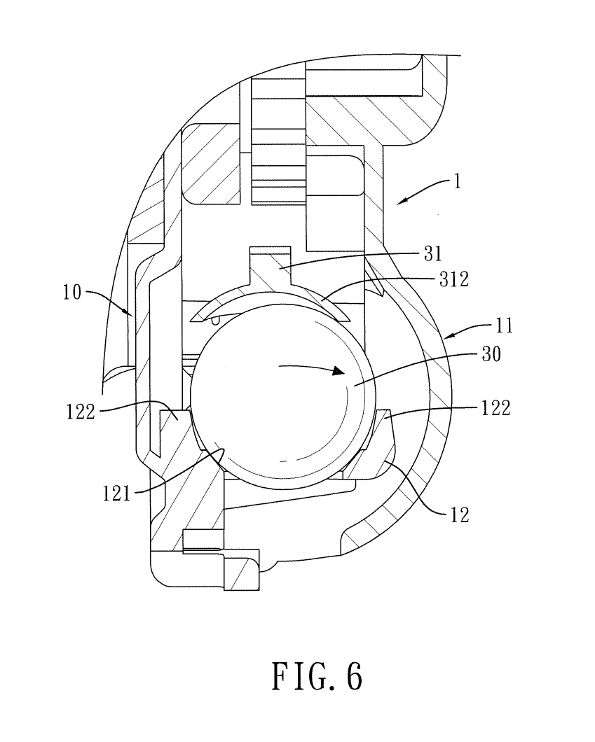

With reference to FIG. 6, when the vehicle drives on a road with a slope and the steel ball 30 moves toward the stopper 122, the steel ball 30 is blocked by the stopper 122 and held in the holding portion 121 of the seat 12, as long as the steel ball deviates at an angle that does not exceed the inclination angle θ. Since the steel ball 30 does not contact and push the rocking arm 31, the safety belt can still be extended or retracted. In turn the driver or the passenger inside the vehicle is not overly tied on the seats by the safety belts unexpectedly and repeatedly due to a bumpy road condition. Accordingly, driving safety and comfort can be both taken into account. Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An engagement device of a safety belt adapted to be mounted on a safety belt retractor of the safety belt, comprising:
a body being hollow and having:
a seat formed on a lower portion inside the body and having:
a holding portion circularly formed in the seat and having a center and a bottom; and
at least one stopper formed around a perimeter of the holding portion, each one of the at least one stopper having a top inner edge;
an actuating assembly mounted inside the body and having:
a ratchet wheel adapted to connect with a rotation shaft of the safety belt retractor; and
multiple ratchet teeth formed around a perimeter of the ratchet wheel; and
a stopping assembly having:
a steel ball rotatably mounted on the holding portion of the seat; and
a rocking arm having:
one end pivotally mounted on an inside portion of the body;
a pawl formed on the other end of the rocking arm for engaging in between the ratchet teeth of the ratchet wheel and preventing the ratchet wheel from rotating; and
a middle portion abutting against the steel ball.

2. The engagement device as claimed in claim 1, wherein the seat of the body has two stoppers aligning with each other symmetrically with respect to the center of the holding portion.

3. The engagement device as claimed in claim 1, wherein
the holding portion of the seat has a hole centrally formed through the bottom of the holding portion; and
the rocking arm further has a cap formed on the middle portion and covering and abutting against the steel ball.

4. The engagement device as claimed in claim 2, wherein
the holding portion of the seat has a hole centrally formed through the bottom of the holding portion; and
the rocking arm further has a cap formed on the middle portion and covering and abutting against the steel ball.

5. The engagement device as claimed in claim 1, wherein
the body further has:
a fixed part adapted to be mounted on one side of the safety belt retractor; and
a detachable part assembled with the fixed part to cover the fixed part; and
the seat of the body is formed on a lower portion inside the fixed part.

6. The engagement device as claimed in claim 2, wherein
the body further has:
a fixed part adapted to be mounted on one side of the safety belt retractor; and
a detachable part assembled with the fixed part to cover the fixed part; and
the seat of the body is formed on a lower portion inside the fixed part.

7. The engagement device as claimed in claim 3, wherein
the body further has:
a fixed part adapted to be mounted on one side of the safety belt retractor; and
a detachable part assembled with the fixed part to cover the fixed part; and
the seat of the body is formed on a lower portion inside the fixed part.

8. The engagement device as claimed in claim 4, wherein
the body further has:
a fixed part adapted to be mounted on one side of the safety belt retractor; and
a detachable part assembled with the fixed part to cover the fixed part; and
the seat of the body is formed on a lower portion inside the fixed part.

9. The engagement device as claimed in claim 5, wherein an inclination angle included between a line passing through a center of the steel ball and the top inner edge of each one of the at least one stopper and a line vertically passing through the center of the steel ball is in a range of 27° to 90°.

10. The engagement device as claimed in claim 6, wherein an inclination angle included between a line passing through a center of the steel ball and the top inner edge of each one of the at least one stopper and a line vertically passing through the center of the steel ball is in a range of 27° to 90°.

11. The engagement device as claimed in claim 7, wherein an inclination angle included between a line passing through a center of the steel ball and the top inner edge of each one of the at least one stopper and a line vertically passing through the center of the steel ball is in a range of 27° to 90°.

12. The engagement device as claimed in claim 8, wherein an inclination angle included between a line passing through a center of the steel ball and the top inner edge of each one of the at least one stopper and a line vertically passing through the center of the steel ball is in a range of 27° to 90°.
